(19) United States
(12) Patent Application Publication
(10) Pub. No.: US 2023/0256852 A1
(43) Pub. Date: Aug. 17, 2023

(54) INTELLIGENT CHARGING SCHEDULING ALGORITHM

(71) Applicant: Robert Bosch GmbH, Stuttgart (DE)

(72) Inventor: Mufaddal Zahid Bharmal, Farmington Hills, MI (US)

(21) Appl. No.: 17/585,348

(22) Filed: Jan. 26, 2022

(51) Int. Cl. B60L 53/62

(52) U.S. Cl. CPC B60L 53/62

(57) ABSTRACT

A system for controlling charging of an electric vehicle. The system includes an electronic controller configured to estimate a vehicle usage of the electric vehicle for a defined time-period using an artificial intelligence engine. The electronic controller is also configured to determine peak and off-peak hours for charging the electric vehicle. The electronic controller is further configured to determine a charging time to reach a maximum target state of charge for the electric vehicle. The electronic controller is also configured to create a charging schedule for the electric vehicle to reach the maximum target state of charge based on the vehicle usage, the peak and off-peak hours, and the charging time associated with the electric vehicle. The electronic controller is further configured to control charging of the electric vehicle according to the charging schedule responsive to determining the electric vehicle reaches a minimum target state of charge.

### BACKGROUND

Charging the batteries of electric vehicles is, in general, a manual process driven in large party by human decisions made by a driver. For example, a driver may connect his vehicle to a battery charger when a charge level of the vehicle battery reaches a relatively low level, for example, twenty percent charge remaining. In some cases, however, a driver may charge a vehicle at night regardless of the state of charge of the battery. Existing chargers may include intelligence to stop the charging process when a battery reaches a maximum state of charge, but otherwise the charging process is, as explained, subject to decisions and habits of the vehicle driver.

### SUMMARY

As noted, charging vehicle batteries is often driven by human decisions. In some cases, charging decisions are based on “range anxiety.” Range anxiety refers to a fear or worry on the part of a driver that an electric vehicle battery will run out of charge before the destination or a suitable charging point is reached. In light of these and other concerns and shortcomings, some embodiments provide a machine-learning-based battery charger that considers factors such as user’s typical daily routine, a current battery state of charge (SOC), the time required to achieve a full charge of the vehicle battery, charging or electricity costs, and, in some instances, others factors to maximize the charging during hours when electricity is available at cheaper rates (often referred to as “off-peak hours”). Certain embodiments also provide the driver (or user) the flexibility to control the maximum SOC to help reduce or overcome range anxiety, particularly when an emergency or unplanned use of the vehicle occurs.

One embodiment provides system for controlling charging of an electric vehicle. The system includes an electronic controller configured to estimate a vehicle usage of the electric vehicle for a defined time-period using an artificial intelligence engine. The electronic controller is also configured to determine peak and off-peak hours for charging the electric vehicle. The electronic controller is further configured to determine a charging time to reach a maximum target state of charge for the electric vehicle. The electronic controller is also configured to create a charging schedule for the electric vehicle to reach the maximum target state of charge based on the vehicle usage, the peak and off-peak hours, and the charging time associated with the electric vehicle. The electronic controller is further configured to control charging of the electric vehicle according to the charging schedule responsive to determining the electric vehicle reaches a minimum target state of charge.

Another embodiment provides an electric vehicle including an electronic controller and a charging device. The charging device enables the electronic controller to control charging of the electric vehicle. The electronic controller is configured to estimate a vehicle usage of the electric vehicle for a defined time-period using an artificial intelligence engine. The electronic controller is also configured to determine peak and off-peak hours for charging the electric vehicle. The electronic controller is further configured to determine a charging time to reach a maximum target state of charge for the electric vehicle. The electronic controller is also configured to create a charging schedule for the electric vehicle to reach the maximum target state of charge based on the vehicle usage, the peak and off-peak hours, and the charging time associated with the electric vehicle. The electronic controller is further configured to control charging of the electric vehicle according to the charging schedule responsive to determining the electric vehicle reaches a minimum target state of charge.

Another embodiment provides a method of controlling charging of an electric vehicle. The method includes estimating, via an electronic controller, a vehicle usage of the electric vehicle for a defined time-period using an artificial intelligence engine. The method also includes determining, via the electronic controller, peak and off-peak hours for charging the electric vehicle. The method further includes determining, via the electronic controller, a charging time to reach a maximum target state of charge for the electric vehicle. The method also includes creating, via the electronic controller, a charging schedule for the electric vehicle to reach the maximum target state of charge based on the vehicle usage, the peak and off-peak hours, and the charging time associated with the electric vehicle. The method further includes controlling, via the electronic controller, charging of the electric vehicle according to the charging schedule responsive to determining the electric vehicle reaches a minimum target state of charge.

Other aspects and embodiments will become apparent by consideration of the detailed description and accompanying drawings.

### BRIEF DESCRIPTION OF THE DRAWINGS

FIG. 1 is a block diagram of an electric vehicle, according to some embodiments.

FIG. 2 is a block diagram of an electronic controller of the electric vehicle of FIG. 1, according to some embodiments.

FIG. 3 is a flow chart of a method for generating a charging schedule of the electric vehicle of FIG. 1, according to some embodiments.

FIG. 4 depicts a graph of timeframes of a charging infrastructure, according to some embodiments.

FIG. 5 is a flow chart of a method for controlling charging of the electric vehicle of FIG. 1, according to some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments illustrated.

The apparatus and method components have been represented where appropriate by conventional symbols in the drawings, showing only those specific details that are pertinent to understanding the embodiments described so as not to obscure the disclosure with details that will be readily apparent to those of ordinary skill in the art having the benefit of the description herein.

### DETAILED DESCRIPTION

Before any embodiments or implementations are explained in detail, it is to be understood that the examples presented herein are not limited in their application to the details of construction and the arrangement of components set forth in the following description or illustrated in the following drawings. Embodiments may be practiced or carried out in various ways.

It should also be noted that a plurality of hardware and software-based devices, as well as a plurality of different structural components may be used to implement the embodiments presented herein. In addition, it should be understood that embodiments may include hardware, software, and electronic components that, for purposes of discussion, may be illustrated and described as if the majority of the components were implemented solely in hardware. However, one of ordinary skill in the art, and based on a reading of this detailed description, would recognize that, in at least one embodiment, the electronic based aspects may be implemented in software (for example, stored on non-transitory computer-readable medium) executable by one or more processors. As a consequence, it should be noted that a plurality of hardware and software-based devices, as well as a plurality of different structural components may be utilized to implement the embodiments presented. For example, “control units” and “controllers” described in the specification can include one or more electronic processors, one or more memory modules including non-transitory computer-readable medium, one or more input/output interfaces, and various connections (for example, a system bus) connecting the components.

For ease of description, each of the example systems presented herein is illustrated with a single exemplar of each of its component parts. Some examples may not describe or illustrate all components of the systems. Other embodiments may include more or fewer of each of the illustrated components, may combine some components, or may include additional or alternative components.

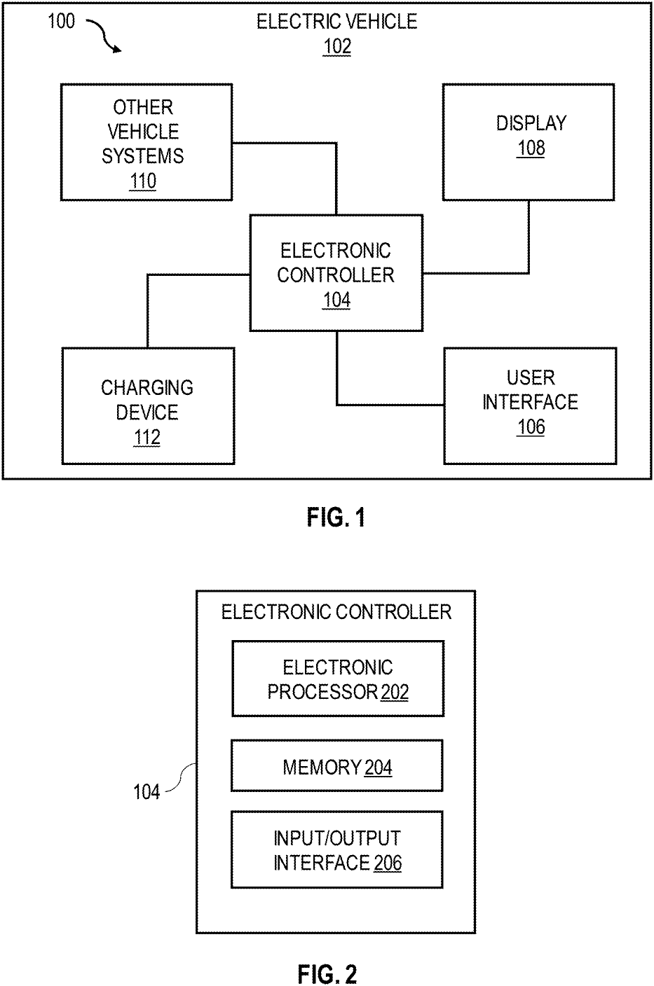

FIG. 1 is a block diagram of one example embodiment of a vehicle charging system 100. In the example shown, the vehicle charging system 100 is integrated into an electric vehicle 102. The vehicle charging system 100 includes an electronic controller 104, a user interface 106, a display 108, and a charging device 112. The electronic controller 104 may be connected to other vehicle systems 110. The electronic controller 104, the user interface 106, the display 108, the other vehicle systems 110, and the charging device 112, as well as other various modules and components of the electric vehicle 102 are communicatively coupled to each other via wired connections, wireless connections, or some combination thereof. All or parts of the connections used in the system 100 may be implemented using various communication networks, for example, a Bluetooth™ network, a control area network (CAN), a wireless local area network (for example, Wi-Fi), and the like. The use of communication networks for the interconnection between and exchange of information among the various modules and components would be apparent to a person skilled in the art in view of the description provided herein.

In some embodiments, the electronic controller 104 includes a plurality of electrical and electronic components that provide power, operational control, and protection to the components within the electronic controller 104. As shown in FIG. 2, the electronic controller 104 includes, among other things, an electronic processor 202 (for example, an electronic microprocessor, microcontroller, or other suitable programmable device), a memory 204, and an input/output interface 206. The electronic processor 202, the memory 204, and the input/output interface 206, as well as the other various components are connected by one or more control or data buses (not shown). In some embodiments, the electronic controller 104 is implemented partially or entirely in hardware (for example, using a field-programmable gate array (“FPGA”), an application specific integrated circuit (“ASIC”), or other devices.

The electronic processor 202 obtains and provides information (for example, from the memory 204 and/or the input/output interface 206) and processes the information by executing one or more software instructions or modules, capable of being stored, for example, in a random access memory (“RAM”) area of the memory 204 or a read only memory (“ROM”) of the memory 204 or another non-transitory computer readable medium (not shown). The software can include firmware, one or more applications, an artificial intelligence (AI) engine, program data, filters, rules, one or more program modules, and other executable instructions. In some implementations, the artificial intelligence engine may include an artificial intelligence model (e.g., a multiple regression analysis model, an artificial neural networks (ANNs) model, a case-based reasoning (CBR) model, etc.), a machine learning model (e.g., a supervised learning model, an unsupervised learning model, a linear regression model, a logistic regression model, a naive Bayes model, etc.), a deep learning model (e.g., a recurrent neural network (RNN) model, a convolution deep neural network (CNN) model, etc.), and/or other AI models.

As noted, the memory 204 can include one or more non-transitory computer-readable media and includes a program storage area and a data storage area. As used in the present application, “non-transitory computer-readable media” comprises all computer-readable media but does not consist of a transitory, propagating signal. The program storage area and the data storage area can include combinations of different types of memory, for example, RAM, ROM, electrically erasable programmable read-only memory (“EEPROM”), flash memory, or other suitable memory devices.

The input/output interface 206 obtains information and signals from, and provides information and signals to (for example, over one or more wired and/or wireless connections) devices and/or components both internal and external to the system 100.

In some embodiments, the electronic controller 104 may include additional, fewer, or different components. For example, in some embodiments, the electronic controller 104 may include a transceiver or separate transmitting and receiving components, for example, a transmitter and a receiver. Some or all of the components of electronic controller 104 may be dispersed and/or integrated into other devices/components of the system 100.

Returning to FIG. 1, the user interface 106 provides an interface between the electric vehicle 102 and a user. The user interface 106 is communicatively coupled to the electronic controller 104 and receives input from the user, receives information from the electronic controller 104, and provides feedback to the user based on the received information. The user interface 106 provides suitable input mechanisms, for example, one or more buttons, a touchscreen display, a voice recognition sub-system, etc. for providing inputs from the user. User inputs may be used by the electronic controller 104 to control the electric vehicle 102 and the charging device 112.

The user interface 106 includes a suitable display device, for example the display 108, for displaying the visual output, for example, an instrument cluster, a heads-up display, a center console display screen (for example, a liquid crystal display (LCD) touch screen, or an organic light-emitting diode (OLED) touch screen), or through other suitable devices. The user interface 106 provides visual output on the display device, for example, via a graphic user interface (GUI) having graphical elements or indicators (for example, fixed or animated icons), lights, colors, text, images, combinations of the foregoing. The GUI displayed on the user interface 106 is, in one example, generated by the electronic controller 104, from instructions and data stored in the memory 204, and presented on a center console display screen.

The user interface 106 may also provide audio output to the user, for example, a chime, buzzer, voice output, or other suitable sound through a speaker included in the user interface 106 or separate from the user interface 106. In some embodiments, the user interface 106 provides a combination of visual, audio, and haptic outputs. In some embodiments, the user interface 106 causes the visual, audio, and haptic outputs to be produced by a smart phone, a smart tablet, a smart watch, or other portable or wearable electronic device communicatively coupled to the electric vehicle 102.

The other vehicle systems 110 may include controllers, sensors, actuators, or other devices for controlling and monitoring aspects of the operation of the electric vehicle 102 (for example, navigation, or other vehicle functions). The other vehicle systems 110 are configured to send and receive data relating to the operation of the electric vehicle 102 to and from the electronic controller 104. For example, in some embodiments, the system 100 may include the charging device 112 coupled to a battery system (not shown) of the electric vehicle 102. The charging device 112 may be configured to enable and disable charging of the battery(ies) of the electric vehicle 102 in response to commands received from, among other things, the electronic controller 104. The charging device 112 may also receive charging commands from the user via the user interface 106 of the electric vehicle 102. In some embodiments, the electronic controller 104 is configured to control charging of a battery (automatically via the charging device 112) of the electric vehicle 102 according to a charging schedule tailored to the user.

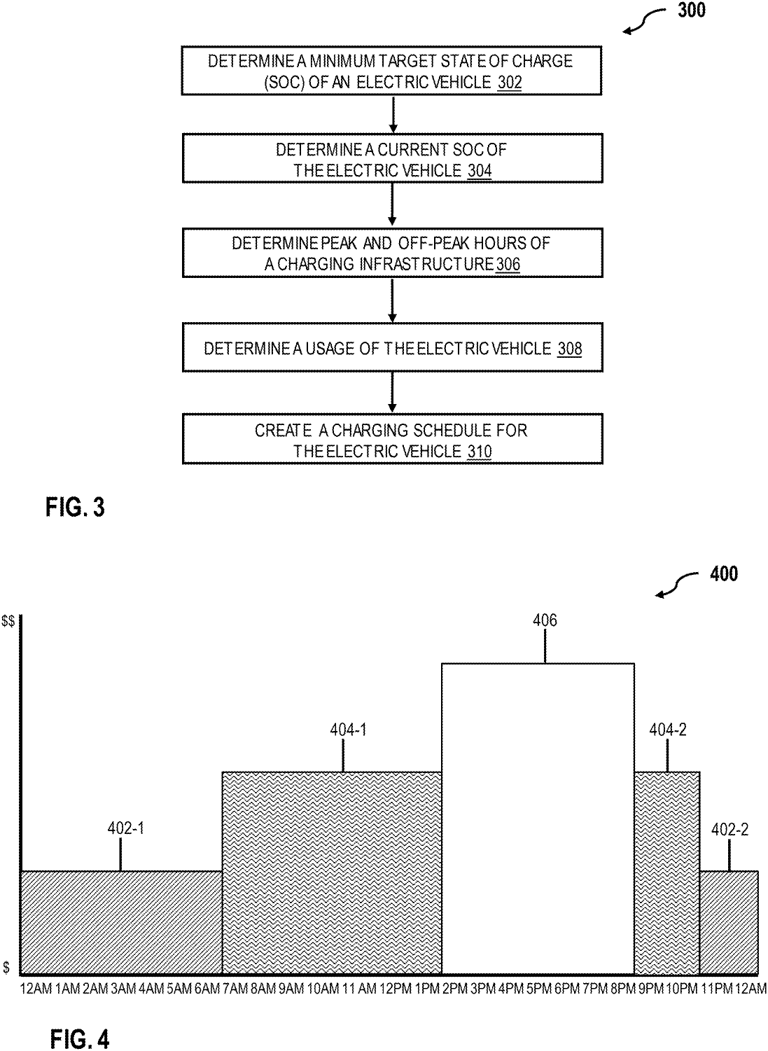

FIG. 3 illustrates an exemplary method 300 for generating a charging schedule for the electric vehicle 102. As an example, the method 300 is explained in terms of the electronic controller 104, and in particular the electronic processor 202. However, it should be understood that portions of the method 300 may be distributed among multiple devices (for example, one or more additional controllers/processors of the system 100).

At block 302, the electronic controller 104 determines a minimum target state of charge of the electric vehicle 102. For example, the input/output interface 206 may receive an input form a computing device of a user that indicates a minimum target state of charge for the electric vehicle 102. The electronic processor 202 may set the minimum target state of charge of a battery for the electric vehicle 102 to cover expected vehicle usage. In some implementations, the input/output interface 206 receives an input from a computing device of a user that indicates a maximum target state of charge of a battery for the electric vehicle 102. In some implementations, the maximum target state of charge is a predefined threshold charge level to ensure that the electric vehicle 102 can accommodate unforeseen vehicle usage and unplanned vehicle usage events. In one example, the electronic processor 202 sets a maximum target state of charge of a battery for the electric vehicle 102 to cover trips due to unforeseen vehicle usage, for example, unintended use caused by inaccurate or dynamic navigation instructions, inaccurate range prediction of the electric vehicle 102, and others. The electronic processor 202 may also set the maximum target state of charge of the battery for the electric vehicle 102 to cover trips due to unplanned vehicle usage, for example, medical emergencies, changes in the driver’s schedule, and other unplanned trips.

At block 304, the electronic controller 104 determines a current state of charge of the electric vehicle 102. In one example, the input/output interface 206 receives an output signal associated with a level of charge of a battery from a sensor of charging device 112. The electronic processor 202 determines a current state of charge of the battery of the electric vehicle 102 using the output signal.

At block 306, the electronic controller 104 determines peak and off-peak hours of a charging infrastructure. In one example, the input/output interface 206 receives electricity cost rates for a timeframe from a charging infrastructure. The electronic processor 202 uses the electricity cost rates to determine whether the timeframe is a peak, partial peak, or off-peak time-period. The electronic processor 202 may store the electricity cost rates from the charging infrastructure collected over time in the memory 204. In some implementations, the memory 204 includes an artificial intelligence engine that the electronic processor 202 uses to predict/estimate the electricity cost rates of the charging infrastructure for one or more timeframes. For example, the artificial intelligence engine may include a machine learning model trained to predict/estimate electricity cost rates of a charging infrastructure based on historically collected electricity cost rates of the charging infrastructure.

At block 308, the electronic controller 104 determines a usage of the electric vehicle 102. In one example, the input/output interface 206 receives vehicle usage information for the electric vehicle 102 from one or more systems (e.g., other vehicle systems 110) of the electric vehicle 102. The vehicle usage information may include, for example, battery usage, mileage, navigation information, battery state of charge, temperature, charging capacity, charging rate, and other data or information. The electronic processor 202 may determine the usage of the electric vehicle 102 for a defined time-period (e.g., hours, days, weeks, etc.) based on the vehicle usage information. The electronic processor 202 may store the vehicle usage information for the electric vehicle 102 collected over time in the memory 204. In addition, the electronic processor 202 may store schedule information associated with usage of the electric vehicle 102 received from a computing device of a user in the memory 204. The schedule information may include, for example, scheduled appointments, locations corresponding to scheduled appointments, and other data or information of the computing device of the user.

In some implementations, the memory 204 includes a artificial intelligence engine that the electronic processor 202 uses with the collected vehicle usage information to predict the usage of the electric vehicle 102 for one or more defined time-periods. In some implementations, the electronic processor 202 may use the collected vehicle usage information and schedule information to predict the usage of the electric vehicle 102 for one or more defined time-periods. For example, the artificial intelligence engine may include a machine learning model trained to predict the usage of the electric vehicle 102 based on historically collected vehicle usage information of the electric vehicle 102 and schedule information associated with the user.

At block 310, the electronic controller 104 creates a charging schedule for the electric vehicle 102. In one example, the electronic processor 202 determines an amount of time required to charge a battery of the electric vehicle 102 to a maximum target state of charge based on the current state of charge. In certain implementations, the capacity of the battery and the charge rate of a charge point of the charging infrastructure is considered when determining a charging time of the electric vehicle 102. In this example, the electronic processor 202 identifies one or more timeframes associated with the charging infrastructure that satisfy constraints defined by a user. The constraint may be associated with, for example, predefined electricity cost rates, scheduled appointments of a user, time duration of charging, and other data or information. The electronic processor 202 utilizes the determined charging time and the identified timeframes to create a charging schedule that includes a set of conditions and one or more time periods that are suitable for charging the battery of the electric vehicle 102.

FIG. 4 depicts an example cost graph 400 that illustrates multiple timeframes of a charging infrastructure and corresponding electricity cost rates. The cost graph 400 includes a timeframe A 402-1, a timeframe B 404-1, a timeframe C 406, a timeframe D 404-2, and a timeframe E 402-2 (hereinafter timeframes). The timeframe A 402-1 and the timeframe E 402-2 correspond to off-peak timeframes of the charging infrastructure, which are indicative of low electricity cost rates. The timeframe B 404-1 and the timeframe D 404-2 correspond to partial-peak timeframes of the charging infrastructure, which are indicative of moderate electricity cost rates. The timeframe C 406 corresponds to a peak timeframe of the charging infrastructure, which is indicative of high electricity cost rates. In some implementations, the electronic controller 104 generates the cost graph 400 based on historical and/or collected electricity cost rate data. In some instances, the electronic processor 202 identifies/predicts one or more suitable time periods of the timeframes to create a set of time periods for a charging schedule of the electric vehicle 102. In some implementations, the electronic processor 202 selects time periods that result in the lowest electricity cost and/or comply with scheduling constraints of the user in reaching a maximum target state of charge.

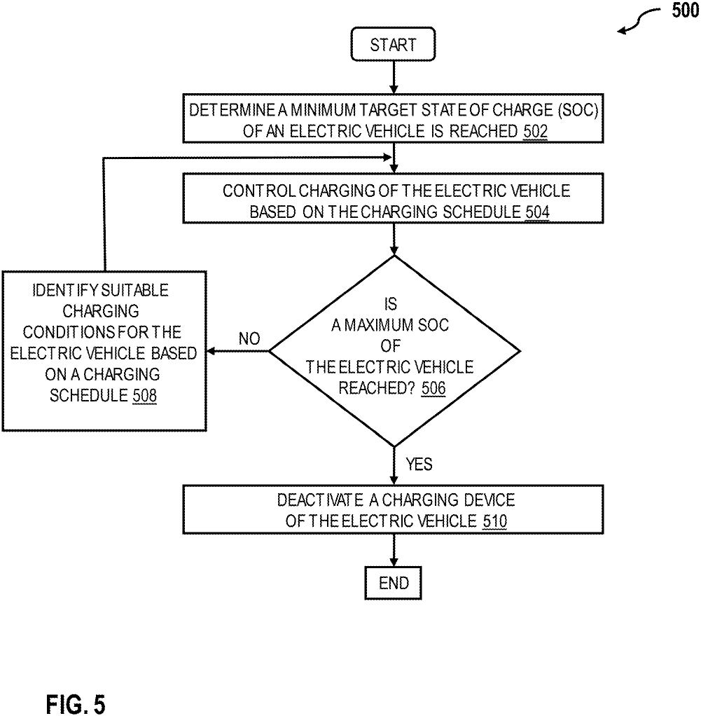

FIG. 5 illustrates an exemplary method 500 for controlling a charging device of the electric vehicle 102 according to a charging schedule. As with method 300, the method 500 is explained in terms of the electronic controller 104, and in particular the electronic processor 202. However, it should be understood that portions of the method 500 may be distributed among multiple devices (for example, one or more additional controllers/processors of the system 100).

At block 502, the electronic controller 104 determines a minimum target state of charge of the electric vehicle 102 is reached. In one example, the input/output interface 206 continuously receives an output signal associated with a level of charge of a battery of the electric vehicle 102. The electronic processor 202 determines a current state of charge of the battery based on the received output signals. In this example, the electronic processor 202 compares the current state of charge to the minimum target state of charge. In some instances, the electronic processor 202 determines that the current state of charge is greater than or equal to the minimum target state of charge. In those instances, the electronic processor 202 determines that the battery of the electric vehicle 102 reached the minimum target state of charge.

At block 504, the electronic controller 104 controls charging of the electric vehicle 102 based on the charging schedule. In one example, the electronic processor 202 controls the charging device 112 according to a charging schedule associated with a user. The electronic processor 202 causes the input/output interface 206 to generate and transmit an activation signal to the charging device 112 at a time interval corresponding to the onset of a defined time period of the charging schedule. In some instances, the electronic processor 202 instructs the input/output interface 206 to generate and transmit a deactivation signal to the charging device 112 at a time interval corresponding to the end of the defined time period of the charging schedule. In some implementations, the electronic controller 104 controls charging of the electric vehicle 102 responsive to the electronic processor 202 determining that the minimum target state of charge is reached.

At block 506, the electronic controller 104 determines whether a maximum state of charge of the electric vehicle 102 is reached. In one example, the electronic processor 202 compares a current state of charge of a battery of the electric vehicle 102 to the maximum target state of charge. In some instances, the electronic processor 202 determines that the current state of charge is approximately equal to or greater than the maximum target state of charge. In those instances, the electronic processor 202 determines that the battery of the electric vehicle 102 reaches the maximum target state of charge. In other instances, the electronic processor 202 determines that the current state of charge is less than the maximum target state of charge. In those instances, the electronic processor 202 determines that the battery of the electric vehicle 102 does not reach the maximum target state of charge.

At block 508, the electronic controller 104 identifies suitable charging conditions for the electric vehicle 102 based on a charging schedule. In one example, while the electronic processor 202 controls charging of the electric vehicle 102 according to the charging schedule, the input/output interface 206 receives fluctuating electricity cost rates from a charging infrastructure. The electronic processor 202 uses a constraint of a set of conditions of the charging schedule to determine that the electric vehicle 102 is being charged in accordance with the charging schedule. In this example, the electronic processor 202 uses the constraint to determine that charging conditions, for example, a partial peak timeframe, are suitable for charging the electric vehicle 102 with respect to the charging schedule. In some implementations, the electronic controller 104 continues to identify suitable charging conditions for the electric vehicle 102 responsive to the electronic processor 202 determining that the maximum target state of charge of a battery of the electric vehicle 102 is not reached.

At block 510, the electronic controller 104 deactivates a charging device of the electric vehicle 102. In one example, the electronic processor 202 instructs the input/output interface 206 to generate and transmit a deactivation signal to the charging device 112. The deactivation signal causes the charging device 112 to disable a connection between the electric vehicle 102 and electric vehicle supply equipment of the charging infrastructure. In some implementations, the electronic processor 202 causes the charging device 112 to disable a connection between the electric vehicle 102 and electric vehicle supply equipment in response to determining that a battery of the electric vehicle 102 reached a maximum target state of charge.

Thus, this disclosure provides, among other things, systems, methods, and apparatuses for controlling charging of an electric vehicle by creating a charging schedule for the electric vehicle to reach a maximum target state of charge.

In the foregoing specification, specific embodiments have been described. However, one of ordinary skill in the art appreciates that various modifications and changes can be made without departing from the scope of the claims below. Accordingly, the specification and figures are to be regarded in an illustrative rather than a restrictive sense, and all such modifications are intended to be included within the scope of present teachings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises ... a,” “has ... a,” “includes ... a,” or “contains ... a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

It should be understood that although certain drawings illustrate hardware and software located within particular devices, these depictions are for illustrative purposes only. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Various feature, advantages, and embodiments are set forth in the following claims.

What is claimed is:

1. A system for controlling charging of an electric vehicle, the system comprising:
an electronic controller configured to
estimate a vehicle usage of the electric vehicle for a defined time-period using a artificial intelligence engine;
determine peak and off-peak hours for charging the electric vehicle;
determine a charging time to reach a maximum target state of charge for the electric vehicle;
create a charging schedule for the electric vehicle to reach the maximum target state of charge based on the vehicle usage, the peak and off-peak hours, and the charging time associated with the electric vehicle; and
responsive to determining the electric vehicle reaches a minimum target state of charge, control charging of the electric vehicle according to the charging schedule.

2. The system of claim 1, wherein the electronic controller is further configured to determine one or more time periods for charging the electric vehicle based on the charging schedule.

3. The system of claim 1, wherein the electronic controller is further configured to determine the vehicle usage of the electric vehicle based on a schedule of a user of the electric vehicle.

4. The system of claim 3, wherein the electronic controller is further configured to determine the maximum target state of charge for the electric vehicle to account for unforeseen vehicle usage.

5. The system of claim 3, wherein the electronic controller is further configured to determine the maximum target state of charge for the electric vehicle based on a predefined threshold for unplanned vehicle usage events.

6. The system of claim 1, wherein determining the peak and off-peak hours for charging the electric vehicle comprises the electronic controller further configured to predict off-peak hours for charging the electric vehicle based on a predefined electricity cost using the artificial intelligence engine.

7. An electric vehicle comprising:
an electronic controller;
a charging device, wherein the charging device enables the electronic controller to control charging of the electric vehicle;
wherein the electronic controller is configured to estimate a vehicle usage of the electric vehicle for a defined time-period using an artificial intelligence engine;
wherein the electronic controller is configured to determine peak and off-peak hours for charging the electric vehicle;
wherein the electronic controller is configured to determine a charging time to reach a maximum target state of charge for the electric vehicle;
wherein the electronic controller is configured to create a charging schedule for the electric vehicle to reach the maximum target state of charge based on the vehicle usage, the peak and off-peak hours, and the charging time associated with the electric vehicle; and
wherein the electronic controller is configured to control charging of the electric vehicle according to the charging schedule responsive to determining the electric vehicle reaches a minimum target state of charge.

8. The electric vehicle of claim 7, wherein the electronic controller is further configured to determine one or more time periods for charging the electric vehicle based on the charging schedule.

9. The electric vehicle of claim 7, wherein the electronic controller is further configured to determine the vehicle usage of the electric vehicle based on a schedule of a user of the electric vehicle.

10. The electric vehicle of claim 9, wherein the electronic controller is further configured to determine the maximum target state of charge for the electric vehicle to account for unforeseen vehicle usage.

11. The electric vehicle of claim 9, wherein the electronic controller is further configured to determine the maximum target state of charge for the electric vehicle based on a predefined threshold for unplanned vehicle usage events.

12. The electric vehicle of claim 7, wherein determining the peak and off-peak hours for charging the electric vehicle comprises the electronic controller further configured to predict off-peak hours for charging the electric vehicle based on a predefined electricity cost using the artificial intelligence engine.

13. A method for controlling charging of an electric vehicle, the method comprising:
estimating, via an electronic controller, a vehicle usage of the electric vehicle for a defined time-period using an artificial intelligence engine;
determining, via the electronic controller, peak and off-peak hours for charging the electric vehicle;
determining, via the electronic controller, a charging time to reach a maximum target state of charge for the electric vehicle;
creating, via the electronic controller, a charging schedule for the electric vehicle to reach the maximum target state of charge based on the vehicle usage, the peak and off-peak hours, and the charging time associated with the electric vehicle; and
responsive to determining the electric vehicle reaches a minimum target state of charge, controlling, via the electronic controller, charging of the electric vehicle according to the charging schedule.

14. The method of claim 13, further comprising:
determining, via the electronic controller, one or more time periods for charging the electric vehicle based on the charging schedule.

15. The method of claim 13, further comprising:
determining, via the electronic controller, the vehicle usage of the electric vehicle based on a schedule of a user of the electric vehicle.

16. The method of claim 15, further comprising:
determining, via the electronic controller, the maximum target state of charge for the electric vehicle to account for unforeseen vehicle usage.

17. The method of claim 15, further comprising:
determining, via the electronic controller, the maximum target state of charge for the electric vehicle based on a predefined threshold for unplanned vehicle usage events.

18. The method of claim 15, wherein determining the peak and off-peak hours for charging the electric vehicle, further comprises:
predicting, via the electronic controller, off-peak hours for charging the electric vehicle based on a predefined electricity cost using the artificial intelligence engine.
